(19) United States
(12) Patent Application Publication
(10) Pub. No.: US 2021/0044793 A1
(43) Pub. Date: Feb. 11, 2021

(54) GENERATION METHOD FOR GENERATING FREE VIEWPOINT IMAGE, DISPLAY METHOD FOR DISPLAYING FREE VIEWPOINT IMAGE, FREE VIEWPOINT IMAGE GENERATION DEVICE, AND DISPLAY DEVICE

(71) Applicant: Panasonic Intellectual Property Corporation of America, Torrance, CA (US)

(72) Inventors: Satoshi YOSHIKAWA, Hyogo (JP); Toshiyasu SUGIO, Osaka (JP); Toru MATSUNOBU, Osaka (JP); Tatsuya KOYAMA, Kyoto (JP); Masaki FUKUDA, Osaka (JP)

(21) Appl. No.: 17/077,423

(22) Filed: Oct. 22, 2020

Related U.S. Application Data
(63) Continuation of application No. PCT/JP2019/017658, filed on Apr. 25, 2019.
(60) Provisional application No. 62/663,443, filed on Apr. 27, 2018.

(51) Int. Cl. H04N 13/282; H04N 13/194; H04N 13/275; H04N 5/247

(52) U.S. Cl. CPC H04N 13/282; H04N 5/247; H04N 13/275; H04N 13/194

(57) ABSTRACT

A generation method for generating a free viewpoint image includes: receiving place information and a first time information from a display device, the place information indicating a place shown by the free viewpoint image, the first time information indicating a first time period; transmitting, to the display device, a video generated by imaging the place in the first time period; receiving designated-time information indicating a designated time from the display device, the designated time being input to the display device according to the video such that the designated time is provided in the first time period; generating the free viewpoint image to show the place at the designated time from a free viewpoint; and transmitting the free viewpoint image to the display device.

### CROSS REFERENCE TO RELATED APPLICATIONS

This application is a U.S. continuation application of PCT International Patent Application Number PCT/JP2019/017658 filed on Apr. 25, 2019, claiming the benefit of priority of U.S. Provisional Patent Application No. 62/663,443 filed on Apr. 27, 2018, the entire contents of which are hereby incorporated by reference.

### BACKGROUND

### 1. Technical Field

The present disclosure relates to a generation method for generating a free viewpoint image, a display method for displaying a free viewpoint image, a free viewpoint image generation device, and a display device.

### 2. Description of the Related Art

As a method of distributing multi-viewpoint videos, Japanese Unexamined Patent Application Publication No. 2002-165200 discloses a technique with which videos taken from multiple viewpoints are distributed in unison with viewpoint movements.

Another known technique involves using a group of videos of a specific scene imaged by multiple calibrated cameras to generate a three-dimensional (3D) model of the scene, and using the 3D model to generate a free viewpoint image (a free viewpoint video) of the scene viewed from an arbitrary viewpoint.

### SUMMARY

In accordance with an aspect of the present application, a generation method for generating a free viewpoint image, the generation method including: receiving place information and first time information from a display device, the place information indicating a place shown by the free viewpoint image, the first time information indicating a first time period; transmitting, to the display device, a video generated by imaging the place in the first time period; receiving designated-time information indicating a designated time from the display device, the designated time being input to the display device according to the video such that the designated time is provided in the first time period; generating the free viewpoint image to show the place at the designated time from a free viewpoint; and transmitting the free viewpoint image to the display device.

In accordance with another aspect of the present application, a display method for displaying a free viewpoint image, the display method including: transmitting place information and first time information to a free viewpoint image generation device, the place information indicating a place shown by the free viewpoint image, the first time information indicating a first time period; receiving, from the free viewpoint image generation device, a video generated by imaging the place in the first time period; displaying a first user interface for selecting a designated time from the first time period according to the video; transmitting, to the free viewpoint image generation device, designated-time information indicating the designated time selected via the first user interface; receiving, from the free viewpoint image generation device, the free viewpoint image showing the place at the designated time from a free viewpoint; and displaying the free viewpoint image.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a diagram showing an overview of a free viewpoint image generation system according to an embodiment;

FIG. 2 is a diagram showing a configuration of the free viewpoint image generation system according to the embodiment;

FIG. 3 is a block diagram of a free viewpoint image generation device according to the embodiment;

FIG. 4 is a block diagram of a display device according to the embodiment;

FIG. 5 is a sequence diagram showing operations of the free viewpoint image generation system according to the embodiment;

FIG. 6 is a flowchart of a start signal transmission process in the display device according to the embodiment;

FIG. 7A is a diagram showing an example of a setting screen according to the embodiment;

FIG. 7B is a diagram showing an example of the setting screen according to the embodiment;

FIG. 8 is a flowchart showing a process in the free viewpoint image generation device according to the embodiment, upon receiving a start signal;

FIG. 9 is a flowchart showing a camera video generation process in the free viewpoint image generation device according to the embodiment;

FIG. 10 is a flowchart showing a designated time selection process in the display device according to the embodiment;

FIG. 11 is a diagram showing an example of a distributed video display screen according to the embodiment;

FIG. 12 is a flowchart of a 3D model generation process in the free viewpoint image generation device according to the embodiment;

FIG. 13 is a flowchart showing a viewpoint selection process in the display device according to the embodiment;

FIG. 14 is a diagram showing an example of a 3D model display screen according to the embodiment;

FIG. 15 is a flowchart showing a free viewpoint image generation process in the free viewpoint image generation device according to the embodiment;

FIG. 16 is a flowchart showing a free viewpoint image display process in the display device according to the embodiment;

FIG. 17 is a diagram showing an example of a free viewpoint image display screen according to the embodiment;

FIG. 18 is a flowchart of a process in the free viewpoint image generation device according to the embodiment; and

FIG. 19 is a flowchart of a process in the display device according to the embodiment.

### DETAILED DESCRIPTION OF THE EMBODIMENT

In accordance with an aspect of the present application, a generation method for generating a free viewpoint image includes: receiving place information and first time information from a display device, the place information indicating a place shown by the free viewpoint image, the first time information indicating a first time period; transmitting, to the display device, a video generated by imaging the place in the first time period; receiving designated-time information indicating a designated time from the display device, the designated time being input to the display device according to the video such that the designated time is provided in the first time period; generating the free viewpoint image to show the place at the designated time from a free viewpoint; and transmitting the free viewpoint image to the display device

The generation method enables a user of the display device to select a designated time with reference to the video. As a result, the user can easily select a target of a free viewpoint image.

For example, it is possible that the generation method further includes: receiving second time information indicating a second time period from the display device prior to the receiving of the first time information, the second time period being a time period of imaging the place and including the first time period; and transmitting thumbnail images of the place to the display device, the thumbnail images corresponding to a plurality of times in the second time period, wherein the first time period is designated with reference to the thumbnail images in the display device.

This enables the user of the display device to designate a more specific time period with reference to the thumbnail images. As a result, the user can easily select a target of a free viewpoint image.

For example, it is also possible that the generation method further includes: generating a three-dimensional (3D) model to show the place at the designated time from a free viewpoint; transmitting the 3D model to the display device; and receiving, from the display device, viewpoint information indicating a viewpoint selected with reference to the 3D model in the display device, wherein the free viewpoint image is an image viewed from the viewpoint selected.

This enables the user of the display device to select a viewpoint of the free viewpoint image with reference to the 3D model. As a result, the user can easily select the viewpoint of the free viewpoint image.

In accordance with another aspect of the present application, a display method for displaying a free viewpoint image includes: transmitting place information and first time information to a free viewpoint image generation device, the place information indicating a place shown by the free viewpoint image, the first time information indicating a first time period; receiving, from the free viewpoint image generation device, a video generated by imaging the place in the first time period; displaying a first user interface for selecting a designated time from the first time period according to the video; transmitting, to the free viewpoint image generation device, designated-time information indicating the designated time selected via the first user interface; receiving, from the free viewpoint image generation device, the free viewpoint image showing the place at the designated time from a free viewpoint; and displaying the free viewpoint image.

The display method enables a user of the display device to select a designated time with reference to the video. As a result, the user can easily select a target of a free viewpoint image.

For example, it is possible that the display method further includes: transmitting second time information indicating a second time period to the free viewpoint image generation device prior to the transmitting of the first time information, the second time period being a time period of imaging the place and including the first time period; and receiving thumbnail images of the place from the free viewpoint image generation device, the thumbnail images corresponding to a plurality of times in the second time period; and displaying a second user interface for designating the first time period with reference to the thumbnail images, wherein the first time period is designated via the second user interface.

This enables the user of the display device to designate a more specific time period with reference to the thumbnail images. As a result, the user can easily select a target of a free viewpoint image.

For example, it is also possible that the display method further includes: receiving, from the free viewpoint image generation device, a 3D model showing the place at the designated time from a free viewpoint; displaying a third user interface for selecting a viewpoint with reference to the 3D model; and transmitting, to the free viewpoint image generation device, viewpoint information indicating the viewpoint selected via the third user interface, wherein the free viewpoint image is an image viewed from the viewpoint selected.

This enables the user of the display device to select a viewpoint of the free viewpoint image with reference to the 3D model. As a result, the user can easily select the viewpoint of the free viewpoint image.

In accordance with still another aspect of the present application, a free viewpoint image generation device that generates a free viewpoint image includes: a processor; and memory, wherein using the memory, the processor: receives place information and first time information from a display device, the place information indicating a place shown by the free viewpoint image, the first time information indicating a first time period; transmits, to the display device, a video generated by imaging the place in the first time period; receives designated-time information indicating a designated time from the display device, the designated time being input to the display device according to the video such that the designated time is provided in the first time period; generates the free viewpoint image to show the place at the designated time from a free viewpoint; and transmits the free viewpoint image to the display device.

The free viewpoint image generation device enables a user of the display device to select a designated time with reference to the video. As a result, the user can easily select a target of a free viewpoint image.

In accordance with still another aspect of the present application, a display device that displays a free viewpoint image includes: a processor; and memory, wherein using the memory, the processor transmits place information and first time information to a free viewpoint image generation device, the place information indicating a place shown by the free viewpoint image, the first time information indicating a first time period; receives, from the free viewpoint image generation device, a video generated by imaging the place in the first time period; displays a first user interface for selecting a designated time from the first time period according to the video; transmits, to the free viewpoint image generation device, designated-time information indicating the designated time selected via the first user interface; receives, from the free viewpoint image generation device, the free viewpoint image showing the place at the designated time from a free viewpoint; and displays the free viewpoint image.

The display device enables a user to select a designated time with reference to the video. As a result, the user can easily select a target of a free viewpoint image.

These general and specific aspects may be implemented to a system, a method, an integrated circuit, a computer program, or a computer-readable recording medium such as a Compact Disc-Read Only Memory (CD-ROM), or may be any combination of them.

Hereinafter, certain exemplary embodiments will be described in detail with reference to the accompanying Drawings. The following embodiments are specific examples of the present disclosure. The numerical values, shapes, materials, elements, arrangement and connection configuration of the elements, steps, the order of the steps, etc., described in the following embodiments are merely examples, and are not intended to limit the present disclosure.

In this embodiment, a free viewpoint image generation system will be described that can facilitate generating a free viewpoint image using multi-viewpoint cameras and videos taken by the cameras.

By using multiple camera videos and free viewpoint images, videos viewed from various directions can be acquired and generated. This enables providing videos that meet the needs of various viewers (for example, a close-up video of a player A or a long-shot video).

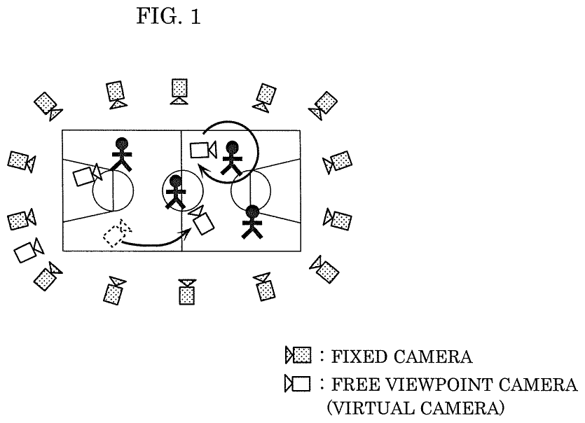

FIG. 1 is a diagram showing an overview of a free viewpoint image generation system. For example, a space can be imaged from multiple viewpoints with calibrated cameras (for example, cameras at fixed positions) to three-dimensionally reconstruct the space (3D space reconstruction). The resulting three-dimensionally reconstructed data can be used to perform tracking, scene analysis, and video rendering, thereby generating a video viewed from an arbitrary viewpoint (a free viewpoint camera). This can implement next-generation wide-area monitoring systems and free viewpoint image generation systems.

To generate a free viewpoint image with user-desired timing, however, the user needs to set a desired time and viewpoint. Unfortunately, it is not easy for the user to readily set the time and the viewpoint, which belong to different dimensions.

To realize this, the time and the viewpoint need to be set with independent and sequential operations.

In a free viewpoint image generation system according to an aspect of the present disclosure, a display device uses place information and time period information to acquire a camera video that covers a time desired for generating a free viewpoint image. The display device then refers to the camera video to designate the time desired for generating the free viewpoint image, and refers to a 3D model to designate a viewpoint desired for generating the free viewpoint image. This can implement a system that allows easily acquiring a user-desired free viewpoint image.

The user can therefore perform, in a sequential process, complicated process steps for acquiring a free viewpoint image from a camera video. As a result, the user can readily use free viewpoint images.

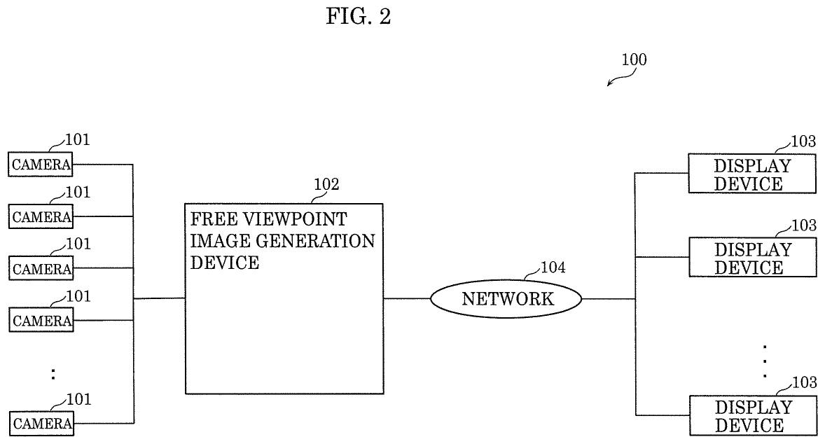

The configuration of free viewpoint image generation system 100 according to this embodiment will be described below. FIG. 2 is a diagram showing an exemplary configuration of free viewpoint image generation system 100 according to this embodiment. Free viewpoint image generation system 100 includes cameras 101, free viewpoint image generation device 102, and display devices 103.

Cameras 101 generate camera videos by imaging the same scene from different viewpoints. For example, cameras 101 may perform synchronous shooting. Cameras 101 may also embed time information in the videos or attach index information indicating the frame order to the videos.

Free viewpoint image generation device 102, which is a server that generates free viewpoint images, acquires the camera videos taken by cameras 101 and uses the camera videos to generate a 3D model and a free viewpoint image. Free viewpoint image generation device 102 is connected to display devices 103 over network 104. Free viewpoint image generation device 102 transmits a camera video, the 3D model, and the free viewpoint image to display device 103. Specifically, free viewpoint image generation device 102 generates a 3D model and a free viewpoint image based on time information and viewpoint information transmitted from display device 103, and transmits the generated 3D model and free viewpoint image to display device 103. In doing so, free viewpoint image generation device 102 may generate a free viewpoint image using the 3D model, or generate a free viewpoint video by interpolation between two or more images.

Each display device 103 is a terminal that displays, for presentation to a user, the camera video, the 3D model, and the free viewpoint image transmitted from free viewpoint image generation device 102. Display device 103 also selects a time from the camera video, selects a viewpoint from the 3D model, and transmits these selected pieces of information to free viewpoint image generation device 102.

Communication between free viewpoint image generation device 102 and display devices 103 may be based on any scheme capable of data exchange. For example, communication between remote locations may be performed over the Internet, and communication within a place such as a laboratory may be performed on a LAN.

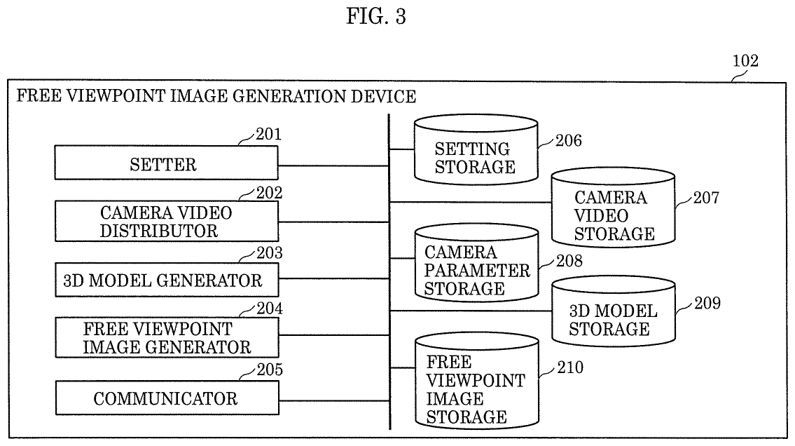

FIG. 3 is a block diagram of free viewpoint image generation device 102 according to this embodiment. Free viewpoint image generation device 102 includes setter 201, camera video distributor 202, 3D model generator 203, free viewpoint image generator 204, communicator 205, setting storage 206, camera video storage 207, camera parameter storage 208, 3D model storage 209, and free viewpoint image storage 210.

Setter 201 sets a set time and a set place, which are the time and place of a video to be used in generating a free viewpoint image, and saves information indicating the set time and the set place in setting storage 206. For example, for inspecting an accident site, a period of some minutes before and after the moment of the accident is set as the set time, and the accident site is set as the set place. For example, setter 201 sets, as the set time and the set place, a time and a place designated by display device 103 via communicator 205. Setter 201 may also automatically set the set place and the set time by recognizing an accident with image processing such as crowd detection, and notify display device 103 of the set place and the set time.

Camera video distributor 202 acquires a camera video corresponding to the set time and the set place set by setter 201 and transmits the acquired camera video to display device 103.

3D model generator 203 receives a time desired for generating a 3D model from display device 103 and generates the 3D model for the desired time. 3D model generator 203 transmits the generated 3D model to display device 103 while saving the 3D model in 3D model storage 209. For example, 3D model generator 203 generates the 3D model by performing 3D reconstruction using an image processing technique such as SfM (Structure from Motion). If the camera video includes depth information, 3D model generator 203 may generate the 3D model using the depth information.

Free viewpoint image generator 204 receives viewpoint information transmitted from display device 103, generates a free viewpoint image viewed from the designated viewpoint, and transmits the generated free viewpoint image to display device 103. Free viewpoint image generator 204 also saves the generated free viewpoint image in free viewpoint image storage 210. For example, free viewpoint image generator 204 generates the free viewpoint image using the 3D model. Free viewpoint image generator 204 may also generate the free viewpoint image by 2D interpolation between camera images as in morphing processing. The free viewpoint image (the free viewpoint video) may be a still image or a moving image. The moving image may be a moving image showing changes over time of a specific scene viewed from a certain viewpoint, or may be a moving image in which the viewpoint is continuously changed at a designated time, or may be a combination of the above.

Communicator 205 is responsible for data exchange by setter 201, camera video distributor 202, 3D model generator 203, and free viewpoint image generator 204 to and from display devices 103.

Setting storage 206 stores information about general processing related to time periods and places desired for generating free viewpoint images.

Camera video storage 207 stores camera videos taken by cameras 101. Specifically, camera video storage 207 saves camera videos directly acquired from cameras 101. Camera video storage 207 may also save camera videos acquired indirectly via other apparatuses.

Camera parameter storage 208 stores camera parameters including information about the 3D positions and orientations of cameras 101 that took camera videos stored in camera video storage 207. This information about the 3D positions and orientations is, for example, information acquired by a GPS or a gyro sensor provided in each camera 101. Free viewpoint image generation device 102 may also estimate the 3D positions and orientations by subjecting the camera videos to an image processing technique such as SfM.

3D model storage 209 stores 3D models generated by 3D model generator 203.

Free viewpoint image storage 210 stores free-viewpoint images generated by free viewpoint image generator 204.

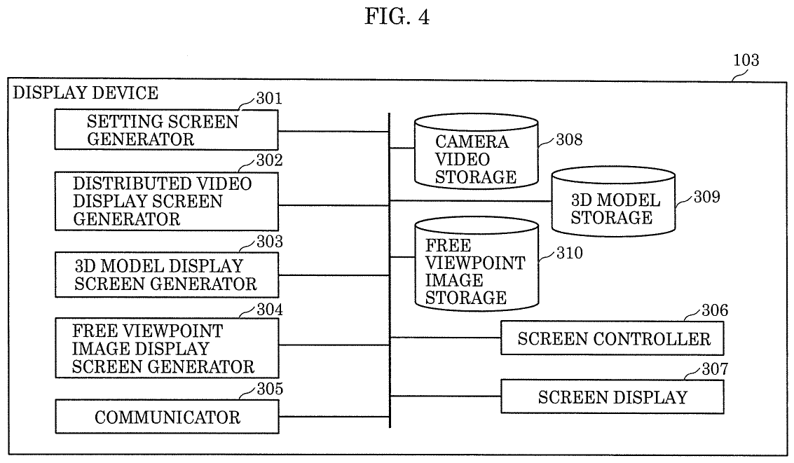

FIG. 4 is a block diagram of each display device 103 according to this embodiment. Display device 103 includes setting screen generator 301, distributed video display screen generator 302, 3D model display screen generator 303, free viewpoint image display screen generator 304, communicator 305, screen controller 306, screen display 307, camera video storage 308, 3D model storage 309, and free viewpoint image storage 310.

Setting screen generator 301 generates a setting screen, which is an interface for generating a start signal. The start signal includes time period information and place information for acquiring a video that covers a time desired for generating a free viewpoint image. A screen may contain not only still images but also moving images, as well as icons and operation sections such that their displayed forms changes with time.

Distributed video display screen generator 302 generates a distributed video display screen, which is an interface for selecting, from the acquired camera video, the time desired for generating the free viewpoint image.

3D model display screen generator 303 generates a 3D model display screen, which is an interface for determining, according to an acquired 3D model, a viewpoint for generating the free viewpoint image.

Free viewpoint image display screen generator 304 generates a free viewpoint image display screen, which is a screen for displaying the acquired free viewpoint image.

Communicator 305 communicates with free viewpoint image generation device 102 to transmit and receive information used by setting screen generator 301, distributed video display screen generator 302, 3D model display screen generator 303, and free viewpoint image display screen generator 304.

Screen controller 306 determines which screen is to be displayed on screen display 307 among the display screens generated by setting screen generator 301, distributed video display screen generator 302, 3D model display screen generator 303, and free viewpoint image display screen generator 304, and controls the timing of displaying the screen.

Screen controller 306 also acquires user operations performed on screen display 307 and sends information related to the user operations to setting screen generator 301, distributed video display screen generator 302, 3D model display screen generator 303, and free viewpoint image display screen generator 304.

Screen display 307 presents various sorts of information to the user by displaying the screens obtained from screen controller 306.

Camera video storage 308 is storage for saving camera videos transmitted from free viewpoint image generation device 102.

3D model storage 309 is storage for saving 3D models transmitted from free viewpoint image generation device 102.

Free viewpoint image storage 310 is storage for saving free viewpoint images transmitted from free viewpoint image generation device 102.

Camera video storage 308, 3D model storage 309, and free viewpoint image storage 310 may be of any type capable of saving temporary or long-term data. These components may be temporary storage such as memory, or may be storage such as an HDD (hard disk drive) capable of storing data for a long term.

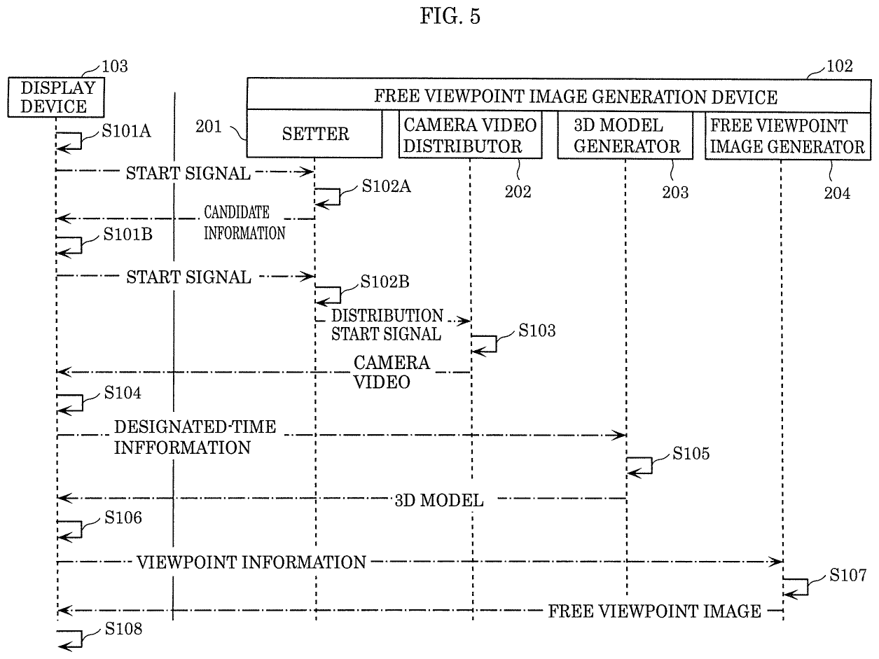

Now, operations of free viewpoint image generation system 100 according to this embodiment will be described. FIG. 5 is a sequence diagram showing operations of free viewpoint image generation system 100 according to this embodiment.

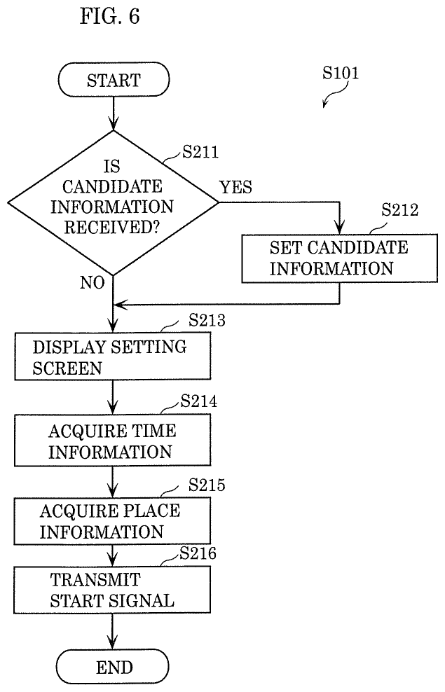

First, display device 103 transmits a start signal to free viewpoint image generation device 102 (S101A and S101B). FIG. 6 is a flowchart of the process (S101) of transmitting the start signal.

First, display device 103 determines whether candidate information is received from free viewpoint image generation device 102 (S211). The candidate information here is, for example, information indicating candidates for the place and the time (time period or time point) of the target of a free viewpoint image.

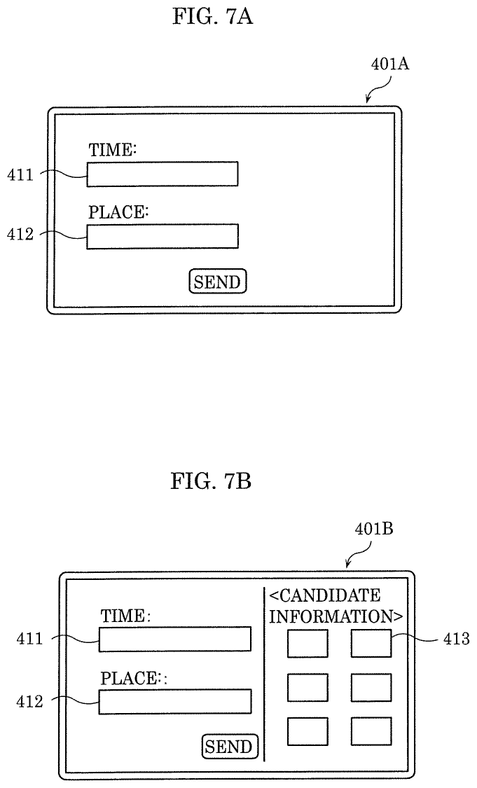

For example, at Step S101A shown in FIG. 5, display device 103 does not receive the candidate information (No at S211). Display device 103 then displays setting screen 401A that does not include candidate information. FIG. 7A is a diagram showing an example of setting screen 401A. Setting screen 401A includes, for example, time input section 411 in which time information is to be input, and place input section 412 in which place information is to be input.

Setting screen 401A illustrated here is a mere example, and display device 103 may have any interface capable of receiving input information for identifying the time and place desired for generating a free viewpoint image. For example, although FIG. 7A shows an example in which time information and place information are input as exemplary input information, other types of information may also be adopted as long as the information allows the user to select a video that covers the time desired for generating a free viewpoint image. The information may be input in any manner, for example, voice input.

At Step S101B shown in FIG. 5, display device 103 receives the candidate information (Yes at S211). Display device 103 then generates setting screen 401B that includes the received candidate information (S212), and displays generated setting screen 401B (S213). FIG. 7B is a diagram showing an example of setting screen 401B. In addition to the content of setting screen 401A, setting screen 401B includes candidate information display section 413 that displays the candidate information. The candidate information is, for example, thumbnail images of a video of a certain place imaged at predetermined time intervals (for example, every five minutes). This information allows the user to estimate the time of an event such as an accident and therefore facilitates the user's selection of the time. In response to the user selecting a thumbnail image, the time corresponding to the thumbnail image may be automatically selected.

After setting screen 401A or 401B is displayed, display device 103 acquires the time information indicating the time input by the user on setting screen 401A or 401B (S214). For example, the user inputs the time information in time input section 411. It should be noted that the time information may be an input of a time in seconds or more broadly in hours. That is, the time information may indicate a time point or a time period.

Display device 103 also acquires the place information input by the user on setting screen 401A or 401B (S215). For example, the user inputs the place information in place input section 412. The place information may be, for example, an address, a proper name such as the name of a crossroad or building, a latitude and a longitude, or an ID (identifier) arbitrarily set by the user. The place information may also indicate a broader place, such as a bay area or an industrial zone. For example, in FIG. 5, a broader place is designated at Step S101A, and then a more specific place is designated at Step S101B.

Display device 103 then transmits, to free viewpoint image generation device 102, a start signal that includes the time information acquired at Step S214 and the place information acquired at Step S215 (S216).

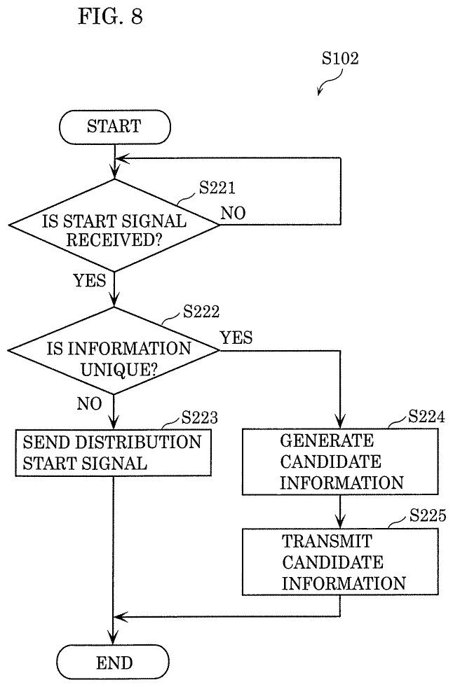

FIG. 8 is a flowchart showing the operations (S102) of setter 201 in free viewpoint image generation device 102 that has received the start signal. First, setter 201 determines whether the start signal is received from display device 103 (S221). If the start signal is not received (No at S221), setter 201 repeats Step S221. That is, setter 201 waits until the start signal is received.

If the start signal is received (Yes at S221), setter 201 determines whether information included in the received start signal (the place information and the time information) is unique (S222). The information being unique here means that the place information and the time information can uniquely identify a video to be transmitted to display device 103. As an example, this may be the case in which a video of crossroad A at 13:00:00 is identified.

If the information is unique (Yes at S222), setter 201 sends, to camera video distributor 202, a distribution start signal for starting the distribution of the video uniquely identified by the information included in the start signal (S223). For example, at Step S102B shown in FIG. 5, the information is unique and therefore setter 201 sends the distribution start signal to camera video distributor 202.

If the information is not unique (No at S222), setter 201 generates candidate information by acquiring or generating information necessary for clarifying unspecific information included in the start signal (S224). The unspecific information here means that, for the time information, the information includes a period longer than a certain length, such as around noon or in the morning, rather than 13:00:00. An example of the candidate information in such a case is a group of thumbnail images for every 10 minutes around noon from 11:00 to 13:00.

Setter 201 then transmits the generated candidate information to display device 103 (S225). Setter 201 can thus help in narrowing down the information in the start signal to unique information. For example, at Step S102A shown in FIG. 5, the information is not unique and therefore setter 201 transmits the candidate information to display device 103.

In this manner, if the user inputs broader information, the information is narrowed down. For example, if a broader time is input as the time information, display device 103 acquires thumbnail images for every five minutes and displays them as a list. The user can then find an exact time via a user interface capable of narrowing down, and designate exact time information.

Although the above example mainly illustrates the case in which the time information is not unique, the place information can also be addressed in a similar manner. For example, if a broader place such as an area is designated, display device 103 displays thumbnail images of multiple places included in the area and imaged at the time identified by the time information. The user can then select a desired place from the displayed thumbnail images to designate more specific place information.

These pieces of information need not be input directly by the user. For example, the system may be associated with a database of accident information and use time information and place information in the database.

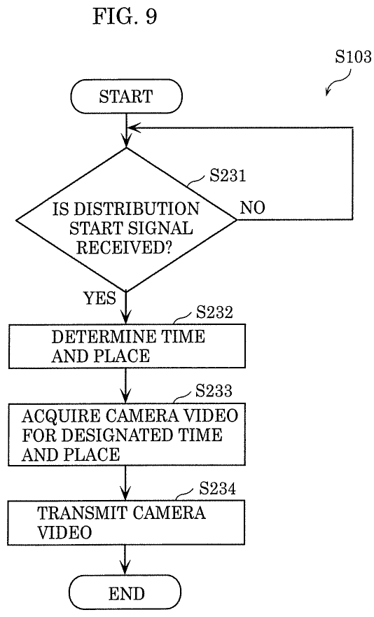

FIG. 9 is a flowchart showing the operations (S103) of camera video distributor 202 that has received the distribution start signal. First, camera video distributor 202 determines whether the distribution start signal is received (S231). If the distribution start signal is not received (No at S231), camera video distributor 202 repeats Step S231. That is, camera video distributor 202 waits until the distribution start signal is received.

If the distribution start signal is received (Yes at S231), camera video distributor 202 acquires the time information and the place information included in the distribution start signal and determines the place and time of the video to be distributed (S232). For example, camera video distributor 202 sets, as the place and time of the video to be distributed, the time and the place indicated by the place information and the time information.

Camera video distributor 202 then acquires, from camera video storage 207, a video corresponding to the place and time determined at Step S232 (S233). If the camera video can be directly acquired from camera 101, such as if the current time is designated, camera video distributor 202 may directly acquire the camera video from camera 101. Finally, camera video distributor 202 transmits the acquired camera video to display device 103 (S234).

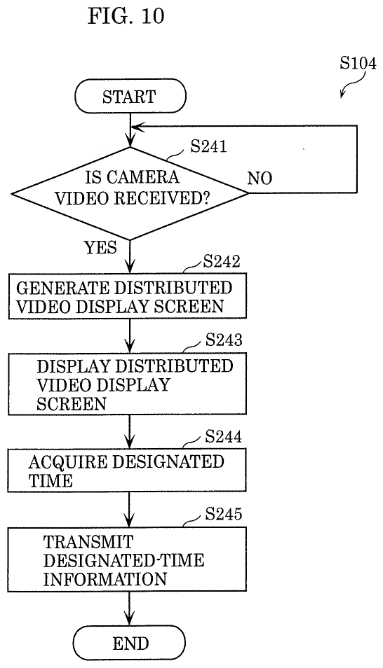

FIG. 10 is a flowchart showing the process (S104) in display device 103 that has received the camera video. First, display device 103 determines whether the camera video is received from free viewpoint image generation device 102 (S241). If the camera video is not received (No at S241), display device 103 repeats Step S241. That is, display device 103 waits until the camera video is received.

If the camera video is received (Yes at S241), display device 103 uses the received camera video to generate distributed video display screen 402 (S242). Display device 103 then presents generated distributed video display screen 402 to the user through screen controller 306 and screen display 307 (S243).

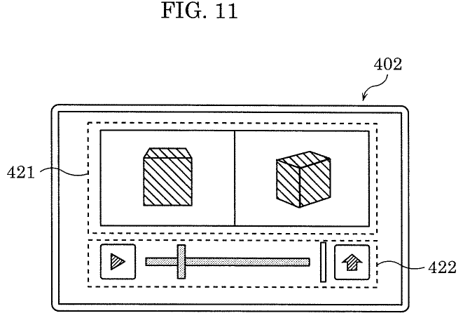

FIG. 11 is a diagram showing an example of distributed video display screen 402. Distributed video display screen 402 includes video display section 421 that displays a received camera video, and operation section 422 for designating the time desired for generating a 3D model.

Display device 103 may receive multiple camera videos and display them in video display section 421. These camera videos are, for example, camera videos of the same scene imaged in the same time period from different viewpoints. Display device 103 may simultaneously display all the camera videos in video display section 421 or may select and display one or more videos viewed from one or more viewpoints out of all the camera videos. If one or more videos are selected, an interface that allows the user to switch among the videos may be provided.

Operation section 422 may have the function of playing and stopping the video, and the function of determining a designated time, which is the time desired for generating a 3D model. In order to facilitate the user's determination of the designated time, operation section 422 may have the function of visualizing time in the video using a slide bar or a time code. Operation section 422 may also have the function of changing the playing speed or the playing direction, such as fast-forward or rewind.

For example, the user may input the designated time by adjusting a slider of a slide bar in operation section 422 to the designated time and performing a confirmation operation (for example, operating an OK button). The designated time may be input not only in this manner but in any manner.

Display device 103 then acquires the designated time input by the user on distributed video display screen 402 (S244). Display device 103 transmits designated-time information indicating the acquired designated time to free viewpoint image generation device 102 (S245).

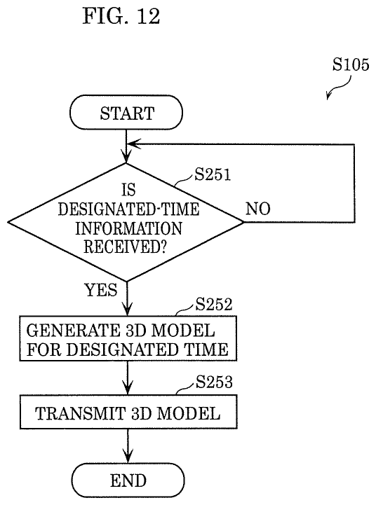

FIG. 12 is a flowchart of the process (S105) in 3D model generator 203 in free viewpoint image generation device 102 that has received the designated-time information. First, 3D model generator 203 determines whether the designated-time information is received from display device 103 (S251). If the designated-time information is not received (No at S251), 3D model generator 203 repeats Step S251. That is, 3D model generator 203 waits until the designated-time information is received.

If the designated-time information is received (Yes at S251), 3D model generator 203 generates a 3D model for the designated time indicated by the designated-time information (S252). For example, 3D model generator 203 generates the 3D model using PMVS (Patch-based Multi View Stereo). Specifically, based on feature points corresponding to features in images, such as corners of an object, 3D model generator 203 determines identical feature points among the images. 3D model generator 203 then subjects the determined feature points to 3D survey using camera parameters including the 3D orientations of the cameras, thereby generating the 3D model. 3D model generator 203 may also generate the 3D model using the volume intersection method. That is, 3D model generator 203 may generate the 3D model by three-dimensionally integrating object areas imaged by respective cameras.

Finally, 3D model generator 203 transmits the generated 3D model to display device 103 (S253).

The information on the 3D model may be transmitted to display device 103 in any manner. For example, 3D model generator 203 may write the 3D model as some form of file such as a text file and transmit the file. 3D model generator 203 may also stream the data on the generated 3D model as appropriate. The former manner facilitates time-based management of the 3D model in free viewpoint image generation device 102 and in display device 103. The latter manner can reduce the time required for transmission to display device 103.

After generating the 3D model for the designated time, 3D model generator 203 may start generating 3D models for times before and after the designated time. For example, if the time n is designated, 3D model generator 203 may automatically generate 3D models for the times n+1 and n−1 after generating and transmitting the 3D model for the time n. 3D model generator 203 may or may not transmit the generated 3D models for the times n+1 and n−1 to display device 103. In this manner, 3D models for several frames before and after the designated time, for example, 3D models for times before and after the moment of a traffic accident, are proactively generated. Because the user is likely to want to view free viewpoint images at times around the designated time, proactively generating corresponding 3D models eliminates the time required for waiting until the 3D models are generated, thereby reducing the user's waiting time.

3D model generator 203 may generate 3D models for the designated time and times before and after the designated time at Step S252, and transmit the generated 3D models for these times to display device 103 at Step S253. Alternatively, multiple times or time periods may be designated as the designated-time information, and 3D model generator 203 may generate 3D models for the designated times or time periods and transmit the generated 3D models to display device 103.

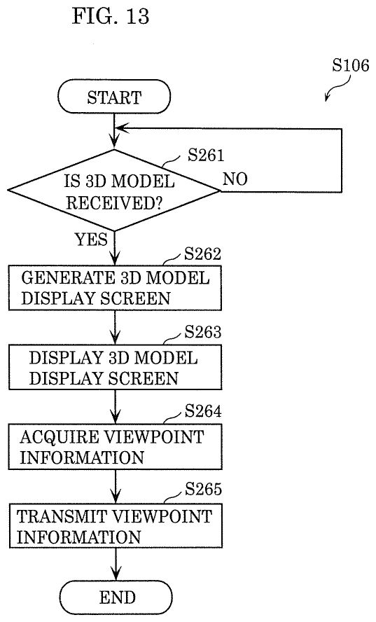

FIG. 13 is a flowchart showing the process (S106) in display device 103 that has received the 3D model. First, display device 103 determines whether the 3D model is received from free viewpoint image generation device 102 (S261). If the 3D model is not received (No at S261), display device 103 repeats Step S261. That is, display device 103 waits until the 3D model is received.

If the 3D model is received (Yes at S261), display device 103 uses the received 3D model to generate 3D model display screen 403 (S262). Display device 103 then presents generated 3D model display screen 403 to the user through screen controller 306 and screen display 307 (S263).

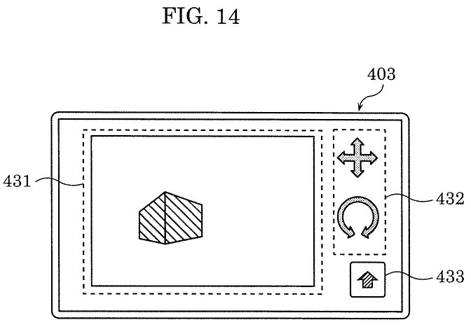

FIG. 14 is a diagram showing an example of 3D model display screen 403. 3D model display screen 403 includes: 3D model display section 431 for displaying a received 3D model; display operation section 432 for operating the 3D model displayed in 3D model display section 431; and viewpoint determination section 433 for designating, as viewpoint information to be transmitted to free viewpoint image generation device 102, the current viewpoint for the displayed 3D model.

3D model display section 431 displays a 2D image of the 3D model viewed from a certain viewpoint. For example, display device 103 sets, as the initial display viewpoint, the viewpoint of the camera video displayed on distributed video display screen 402. Display device 103 may also analyze information such as coordinate information in the 3D model, and set the initial viewpoint such that an object of interest (for example, the largest object) can be well seen. For example, display device 103 may set the initial viewpoint such that the object of interest is displayed at the center of the image.

Display operation section 432 has the function for the user to perform operations of changing the viewpoint (the virtual camera position) for the image displayed in 3D model display section 431. Specifically, the movement, rotation, etc., of the viewpoint and the gaze point may be controlled to change the position, size, etc., of the view of the 3D model as desired by the user. That is, any interface may be used for this purpose; a keyboard may be used to control viewpoint movements, or interfaces such as buttons may be provided as shown in FIG. 14. The viewpoint may also be controlled by touch operations on 3D model display section 431.

Viewpoint determination section 433 is an operation section for designating, as the viewpoint to be transmitted to free viewpoint image generation device 102, a viewpoint capable of reproducing the current view of the 3D model displayed in 3D model display section 431.

Viewpoint determination section 433 may be included in 3D model display section 431 or display operation section 432. That is, the viewpoint may be determined by the user performing a predetermined operation in 3D model display section 431 or display operation section 432.

Display device 103 thus acquires the viewpoint information indicating the viewpoint designated by the user's operation on 3D model display screen 403 (S264). Finally, display device 103 transmits the acquired viewpoint information to free viewpoint image generation device 102 (S265).

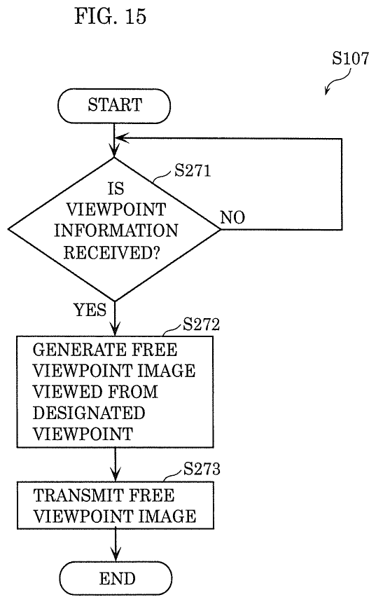

FIG. 15 is a flowchart showing the process (S107) in free viewpoint image generator 204 in free viewpoint image generation device 102 that has received the viewpoint information. First, free viewpoint image generator 204 determines whether the viewpoint information for generating a free viewpoint image is received from display device 103 (S271). If the viewpoint information is not received (No at S271), free viewpoint image generator 204 repeats Step S271. That is, free viewpoint image generator 204 waits until the viewpoint information is received.

If the viewpoint information is received (Yes at S271), free viewpoint image generator 204 generates a free viewpoint image viewed at the designated time from the viewpoint indicated by the received viewpoint information (S272). For example, free viewpoint image generator 204 generates the free viewpoint image by using the 3D model to assume an actual 3D space and simulating and rendering a view from the designated viewpoint. Free viewpoint image generator 204 may also generate the free viewpoint image by interpolation between two or three camera videos corresponding to viewpoints near the designated viewpoint.

Finally, free viewpoint image generator 204 transmits the generated free viewpoint image to display device 103 (S273).

After generating the free viewpoint image based on the viewpoint information, free viewpoint image generator 204 may generate a free viewpoint image viewed from a neighboring viewpoint. Specifically, free viewpoint image generator 204 may analyze the 3D model to generate a free viewpoint image viewed from a viewpoint more directly facing the object of interest than the designated viewpoint.

Free viewpoint image generator 204 may also generate free viewpoint images viewed from the viewpoint indicated by the viewpoint information and at times before and after the designated time indicated by the designated-time information. The user can then check, as a video, changes over time viewed from the designated viewpoint. This enables effective presentation of information to the user.

Free viewpoint image generator 204 may generate a free viewpoint image viewed at a somewhat wider angle of view than that of the designated viewpoint. Display device 103 can then reproduce the designated viewpoint by combining the display range of the generated image with the designated viewpoint. In this manner, in such cases that the angle of view of the designated viewpoint is narrower than expected, the user can view the surrounding areas without repeating the process of generating a free viewpoint image.

In addition to the free viewpoint image viewed from the designated viewpoint, free viewpoint image generator 204 may also generate an image that has the same position and the same line-of-sight direction but that is more telephotographic. Free viewpoint image generator 204 may transmit the telephoto image along with the designated-viewpoint image to display device 103. Display device 103 can then display these images while switching between the images with a zoom operation performed on display device 103. This enables a high-definition image to be presented to the user still after a zoom operation.

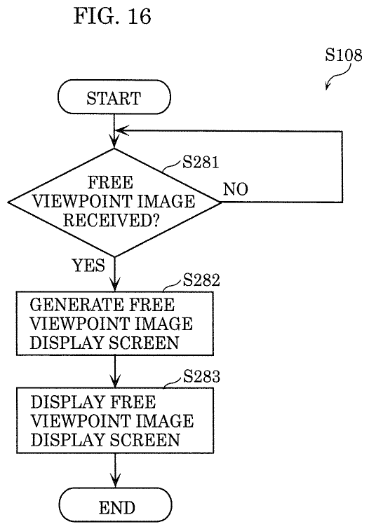

FIG. 16 is a flowchart showing the process (S108) in display device 103 that has received the free viewpoint image. First, display device 103 determines whether the free viewpoint image is received from free viewpoint image generation device 102 (S281). If the free viewpoint image is not received (No at S281), display device 103 repeats Step S281. That is, display device 103 waits until the free viewpoint image is received.

If the free viewpoint image is received (Yes at S281), display device 103 uses the received free viewpoint image to generate free viewpoint image display screen 404 (S282). Display device 103 then presents generated free viewpoint image display screen 404 to the user through screen controller 306 and screen display 307 (S283).

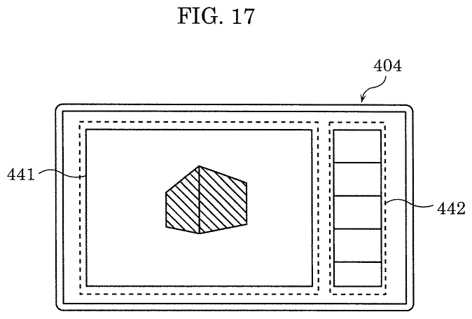

FIG. 17 is a diagram showing an example of free viewpoint image display screen 404. Free viewpoint image display screen 404 includes display section 441 that displays at least an acquired free viewpoint image. Free viewpoint image display screen 404 may also include history section 442 that displays data such as thumbnail images of free viewpoint images generated in the past.

Display section 441 displays the free viewpoint image received from free viewpoint image generation device 102. What is displayed may be a still image. In addition, if multiple free viewpoint images viewed from the same viewpoint at sequential times are generated, these free viewpoint images may be displayed as a free viewpoint video. Operations such as scaling and rotation of the displayed image may be performed in display section 441. These operations may be performed with an interface capable of touch operations, or with a keyboard or a mouse. Free viewpoint image display screen 404 may also include interfaces such as buttons, which may be used to perform such operations.

History section 442 is used for purposes such as reviewing free viewpoint images generated in the past. For example, display device 103 saves every acquired free viewpoint image in free viewpoint image storage 310. Display device 103 can then obtain past free viewpoint images from display device 103 itself for displaying historical data and does not need to generate the free viewpoint images again. This can reduce the processing time.

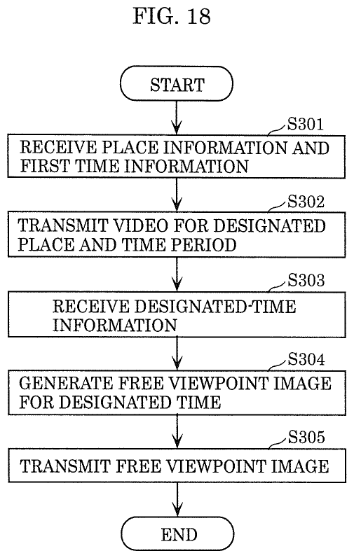

As above, free viewpoint image generation device 102 according to this embodiment performs the process shown in FIG. 18. First, free viewpoint image generation device 102 receives place information and first time information from display device 103, the place information indicating a place that is a target of a free viewpoint image, the first time information indicating a first time period of imaging the target (S301: S102B in FIG. 5 and S221 in FIG. 8). Free viewpoint image generation device 102 then transmits, to display device 103, a video generated by imaging the place in the first time period (a camera video) (S302: S103 in FIGS. 5 and S234 in FIG. 9). Free viewpoint image generation device 102 then receives designated-time information indicating a designated time from display device 103, the designated time being selected from the first time period according to the video in display device 103 (S303: S105 in FIG. 5 and S251 in FIG. 12). Free viewpoint image generation device 102 then generates the free viewpoint image to show the place at the designated time from a free viewpoint (S304: S107 in FIG. 5 and S272 in FIG. 15) and transmits the free viewpoint image to the display device (S305: S107 in FIGS. 5 and S273 in FIG. 15).

This enables the user of display device 103 to select a designated time according to the video. As a result, the user can easily select a target of a free viewpoint image.

Free viewpoint image generation device 102 receives second time information indicating a second time period from display device 103 prior to the receiving of the first time information, the second time period being a time period of imaging the place and including the first time period (S102A in FIGS. 5 and S221 in FIG. 8). Free viewpoint image generation device 102 then transmits thumbnail images (candidate information) of the place to display device 103, the thumbnail images corresponding to multiple times in the second time period (S102A in FIG. 5 and S225 in FIG. 8). The first time period is designated according to the thumbnail images in display device 103.

This enables the user of display device 103 to designate a more specific time period according to the thumbnail images. As a result, the user can easily select a target of a free viewpoint image.

Free viewpoint image generation device 102 further generates a 3D model to show the place at the designated time from a free viewpoint (S105 in FIG. 5 and S252 in FIG. 12), transmits the 3D model to display device 103 (S105 in FIGS. 5 and S253 in FIG. 12), and receives, from display device 103, viewpoint information indicating a selected viewpoint selected according to the 3D model in display device 103 (S107 in FIG. 15 and S271 in FIG. 15). The free viewpoint image is an image viewed from the selected viewpoint.

This enables the user of display device 103 to select a viewpoint of the free viewpoint image according to the 3D model. As a result, the user can easily select the viewpoint of the free viewpoint image.

For example, free viewpoint image generation device 102 includes a processor and a memory, and the processor uses the memory to execute the above process.

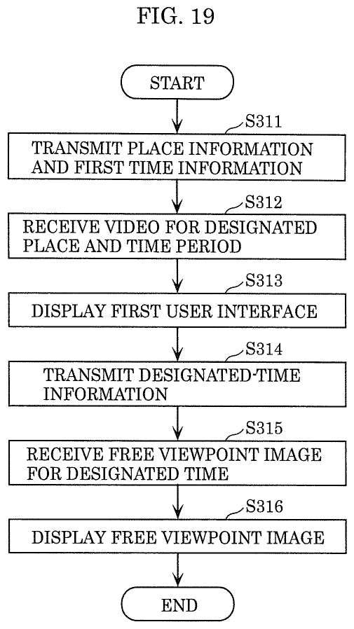

Display device 103 according to this embodiment performs the process shown in FIG. 19. First, display device 103 transmits place information and first time information to free viewpoint image generation device 102, the place information indicating a place that is a target of a free viewpoint image, the first time information indicating a first time period of imaging the target (S311: S101B in FIG. 5 and S216 in FIG. 6). Display device 103 then receives, from free viewpoint image generation device 102, a video (a camera video) generated by imaging the place in the first time period (S312: S104 in FIG. 5 and S241 in FIG. 10).

Display device 103 then displays a first user interface (distributed video display screen 402) for selecting a designated time from the first time period of the video (S313: S104 in FIG. 15 and S243 in FIG. 10). Display device 103 then transmits, to free viewpoint image generation device 102, designated-time information indicating the designated time selected via the first user interface (S314: S104 in FIGS. 5 and S245 in FIG. 10).

Display device 103 then receives, from free viewpoint image generation device 102, the free viewpoint image showing the place at the designated time from a free viewpoint (S315: S108 in FIG. 5 and S281 in FIG. 16). Display device 103 then displays the free viewpoint image (S316: S108 in FIG. 5 and S283 in FIG. 16).

This enables the user of display device 103 to select a designated time according to the video. As a result, the user can easily select a target of a free viewpoint image.

Display device 103 transmits second time information indicating a second time period to free viewpoint image generation device 102 prior to the transmitting of the first time information, the second time period being a time period of imaging the place and including the first time period (S101A in FIGS. 5 and S216 in FIG. 6). Display device 103 receives thumbnail images of the place from free viewpoint image generation device 102, the thumbnail images corresponding to multiple times in the second time period (S101A in FIG. 5 and S211 in FIG. 6). Display device 103 displays a second user interface (setting screen 401B) for designating the first time period according to the thumbnail images (S101A in FIG. 5, and S212 and S213 in FIG. 6). The first time period is designated via the second user interface.

This enables the user of display device 103 to designate a more specific time period according to the thumbnail images. As a result, the user can easily select a target of a free viewpoint image.

Display device 103 further receives, from free viewpoint image generation device 102, a 3D model showing the place at the designated time from a free viewpoint (S106 in FIG. 5 and S261 in FIG. 13), displays a third user interface (3D model display screen 403) for selecting a selected viewpoint according to the 3D model (S106 in FIGS. 5 and S263 in FIG. 13), and transmits, to free viewpoint image generation device 102, viewpoint information indicating the selected viewpoint selected via the third user interface (S106 in FIGS. 5 and S265 in FIG. 13). The free viewpoint image is an image viewed from the selected viewpoint.

This enables the user of display device 103 to select a viewpoint of the free viewpoint image according to the 3D model. As a result, the user can easily select the viewpoint of the free viewpoint image.

For example, display device 103 includes a processor and a memory, and the processor uses the memory to execute the above process.

Although the free viewpoint image generation system according to one or more aspects of the present disclosure has been described based on the embodiments, the present disclosure is not limited to these embodiments.

It should be noted that the processing units included in the free viewpoint image generation system according to each of the above-described embodiments are typically implemented into a Large Scale Integration (LSI) which is an integrated circuit. These may be integrated separately, or a part or all of them may be integrated into a single chip.

The technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

It should be noted that, in the above-described embodiments, each of the constituent elements may be implemented into a dedicated hardware or implemented by executing a software program suitable for the constituent element. Each of the constituent elements may be implemented when a program executing unit, such a central processing unit (CPU) or a processor, reads a software program from a recording medium, such as a hard disk or a semiconductor memory, and executes the readout software program.

The present disclosure may be implemented as various methods, such as a generation method for generating a free viewpoint image or a generation method for displaying a free viewpoint image performed by a free viewpoint image generation system, a free viewpoint image generation device, or a display device.

Separation among the functional blocks in the block diagrams is a mere example; multiple functional blocks may be implemented as a single functional block, or a single functional block may be divided into multiple functional blocks, or some functions may be moved to other functional blocks. Functions of multiple functional blocks having similar functions may be processed by a single hardware or software unit in parallel or in a time-division manner.

The order of the steps in each flowchart is an example for illustrating the present disclosure, and any other orders are possible. Some of the steps may be performed simultaneously (in parallel) with other steps.

Although the free viewpoint image generation system according to one or more aspects of the present disclosure has been described based on the embodiments, the present disclosure is not limited to these embodiments. Those skilled in the art will readily appreciate that embodiments arrived at by making various modifications to the above embodiment or embodiments arrived at by selectively combining elements disclosed in the above embodiment without materially departing from the scope of the present disclosure may be included within one or more aspects of the present disclosure.

### INDUSTRIAL APPLICABILITY

The present disclosure is applicable to systems such as free viewpoint image generation systems.

What is claimed is:

1. A generation method for generating a free viewpoint image, the generation method comprising:
receiving place information and first time information from a display device, the place information indicating a place shown by the free viewpoint image, the first time information indicating a first time period;
transmitting, to the display device, a video generated by imaging the place in the first time period;
receiving designated-time information indicating a designated time from the display device, the designated time being input to the display device according to the video such that the designated time is provided in the first time period;
generating the free viewpoint image to show the place at the designated time from a free viewpoint; and
transmitting the free viewpoint image to the display device.

2. The generation method according to claim 1, further comprising:
receiving second time information indicating a second time period from the display device prior to the receiving of the first time information, the second time period and including the first time period; and
transmitting thumbnail images to the display device, the thumbnail images showing the place a plurality of times in the second time period,
wherein the first time period is designated according to the thumbnail images in the display device.

3. The generation method according to claim 1, further comprising:
generating a three-dimensional (3D) model to show the place at the designated time from a free viewpoint;
transmitting the 3D model to the display device; and
receiving, from the display device, viewpoint information indicating a viewpoint selected according to the 3D model in the display device,
wherein the free viewpoint image is an image viewed from the viewpoint selected.

4. The generation method according to claim 1,
wherein the designated time is input to the display device via a first user interface which is displayed with the video by the display device.

5. A display method for displaying a free viewpoint image, the display method comprising:
transmitting place information and first time information to a free viewpoint image generation device, the place information indicating a place shown by the free viewpoint image, the first time information indicating a first time period;
receiving, from the free viewpoint image generation device, a video generated by imaging the place in the first time period;
displaying a first user interface for selecting a designated time from the first time period according to the video;
transmitting, to the free viewpoint image generation device, designated-time information indicating the designated time selected via the first user interface;
receiving, from the free viewpoint image generation device, the free viewpoint image showing the place at the designated time from a free viewpoint; and
displaying the free viewpoint image.

6. The display method according to claim 5, further comprising:
transmitting second time information indicating a second time period to the free viewpoint image generation device prior to the transmitting of the first time information, the second time period being a time period of imaging the place and including the first time period; and
receiving thumbnail images of the place from the free viewpoint image generation device, the thumbnail images corresponding to a plurality of times in the second time period; and
displaying a second user interface for designating the first time period according to the thumbnail images,
wherein the first time period is designated via the second user interface.

7. The display method according to claim 5, further comprising:
receiving, from the free viewpoint image generation device, a 3D model showing the place at the designated time from a free viewpoint;
displaying a third user interface for selecting a viewpoint according to the 3D model; and
transmitting, to the free viewpoint image generation device, viewpoint information indicating the viewpoint selected via the third user interface,
wherein the free viewpoint image is an image viewed from the viewpoint selected.

8. A free viewpoint image generation device that generates a free viewpoint image, the free viewpoint image generation device comprising:
a processor; and
memory, wherein
using the memory, the processor:
receives place information and first time information from a display device, the place information indicating a place shown by the free viewpoint image, the first time information indicating a first time period;
transmits, to the display device, a video generated by imaging the place in the first time period;
receives designated-time information indicating a designated time from the display device, the designated time being input to the display device according to the video such that the designated time is provided in the first time period;
generates the free viewpoint image to show the place at the designated time from a free viewpoint; and
transmits the free viewpoint image to the display device.

9. A display device that displays a free viewpoint image, the display device comprising:
a processor; and
memory, wherein
using the memory, the processor:
transmits place information and first time information to a free viewpoint image generation device, the place information indicating a place shown by the free viewpoint image, the first time information indicating a first time period;
receives, from the free viewpoint image generation device, a video generated by imaging the place in the first time period;
displays a first user interface for selecting a designated time from the first time period according to the video;
transmits, to the free viewpoint image generation device, designated-time information indicating the designated time selected via the first user interface;
receives, from the free viewpoint image generation device, the free viewpoint image showing the place at the designated time from a free viewpoint; and
displays the free viewpoint image.
